(19) United States
(12) Patent Application Publication
(10) Pub. No.: US 2011/0146496 A1
(43) Pub. Date: Jun. 23, 2011

(54) BEVERAGE PREPARATION DEVICE COMPRISING AN INSERT INSERTED INTO A RECEPTACLE

(75) Inventor: Jørgen Bodum, Meggen (CH)

(73) Assignee: PI-DESIGN AG, Triengen (CH)

(21) Appl. No.: 13/060,865

(22) PCT Filed: Jan. 27, 2009
(86) PCT No.: PCT/CH09/00031

§ 371 Date: Feb. 25, 2011

(30) Foreign Application Priority Data
Aug. 29, 2008 (CH) 01384/08

(51) Int. Cl. A47J 31/44

(52) U.S. Cl. 99/275

(57) ABSTRACT

A beverage preparation device is disclosed which comprises an insert that is inserted into a receptacle and can be interlocked with the receptacle. The beverage preparation device comprises a receptacle (1), a receptacle holder (2), and an insert, e.g. a lid (3) or a holding element. The receptacle holder (2) has at least one element (24) which protrudes from the receptacle (1) and on which at least one engaging structure (26) is provided that cooperates with a second engaging structure (34) on the insert (3) in such a way that the insert is releasably interlocked with the receptacle (1). Preferably, the two engaging structures represent a bayonet joint.

### TECHNICAL FIELD

The present invention relates to a beverage maker comprising an upwardly open receptacle which is held in a receptacle holder, and an insert, for example a lid or an annular retaining element. Beverage makers of this type are used in particular for preparing coffee or tea or for frothing milk.

### PRIOR ART

Plunger-filter coffee makers, which are frequently also referred to as “French Press” coffee makers, have long been known from the prior art. Said beverage makers normally comprise an upwardly open, cylindrical glass receptacle in which a filter plunger is arranged in a vertically displaceable manner. The filter plunger comprises a plunger rod, to the lower end of which a plunger filter with a fine wire or plastics mesh is fitted. The plunger rod is guided through a cover which upwardly covers the receptacle.

In order to prepare, for example, tea or coffee, tea leaves or ground coffee beans are placed into the glass receptacle and hot water is poured thereon. The mixture is left to stand for a few minutes. The filter plunger is subsequently inserted into the glass receptacle and pressed down. In the process, the plunger filter separates the coffee which is ready for drinking from the spent coffee powder. In order to pour the coffee, a beak-like spout is normally formed on the upper rim of the glass receptacle.

In order to ensure protection from spray, the lid, generally having a circumferential skirt, which is perforated in the region of the spout, is pushed loosely into the upper end of the glass receptacle. Since the glass receptacle can have considerable production tolerances, the outside diameter of said skirt is generally a little smaller than the inside diameter of the upper opening of the receptacle, and the connection between the receptacle and lid is therefore normally completely loose. The loose connection of the glass receptacle to the lid gives rise to the risk that the lid may slip as the plunger filter is being pressed down and the beverage may spray out of the glass receptacle. Furthermore, because the lid rests loosely on the glass receptacle, upon incorrect handling or if the beverage maker tips over, hot liquid may escape from the beverage maker, thus causing ready-made coffee to be spilt and the user may be scalded.

### SUMMARY OF THE INVENTION

It is therefore an object of the present invention to specify a beverage maker in which an insert, for example a lid having a drawn-down skirt, is prevented from slipping in the receptacle in order therefore to increase the protection against scalding. To achieve this object, a beverage maker is proposed, as specified in claim 1. Advantageous embodiments of the invention are specified in the dependent claims.

The present invention therefore provides a beverage maker with the following features:
an upwardly open receptacle made of a heat-resistant material, in particular glass, with a receptacle bottom, a circumferential side wall and an upper opening;
a receptacle holder which at least partially embraces the side wall of the receptacle; and
an insert which is inserted into the upper opening in the receptacle and projects into said receptacle, for example by means of a skirt-like region.

The receptacle holder comprises at least one element which protrudes upward over the receptacle and comprises a first engagement structure, for example a groove or a first threaded section. At least one second engagement structure in the form of, for example, a lug or a second threaded section is formed on the insert, said engagement structure interacting with the first engagement structure on the receptacle holder in such a manner that the insert can be locked releasably in relation to the receptacle holder by means of a rotational movement. In the case of a groove and a lug, said groove and lug may also be interchanged with regard to the insert and receptacle holder.

A configuration of this type permits any insert, for example a lid or a retaining ring for a filter, to be fastened lockably to the receptacle without there being the risk, if the beverage maker tips over, that the insert will become detached and, as a result, hot drink will be spilt or the user will be scalded.

The engagement structures preferably form a bayonet joint, i.e. the engagement structures are designed in such a manner that the insert can first of all be pushed into the receptacle vertically from above and can then be rotated essentially about a vertical axis, i.e. in a horizontal direction, through a predefined, limited angular range in relation to the receptacle. Upon this movement, the engagement structures enter into engagement with each other. In a predetermined end position, the engagement structures mutually form a stop which prevents further rotation beyond the end position.

In particular, the beverage maker may be a “French-Press” beverage maker. The receptacle then has a cylindrical basic shape, in which case said receptacle may optionally expand upward a little in an upper rim region. The receptacle is preferably composed of glass and can be of single-walled or double-walled configuration. A vertically displaceable filter plunger is arranged in the receptacle and has a plunger rod, to the upper end of which an actuating element, for example in the form of a gripping knob, is fitted, and to the lower end of which a sieve-like plunger filter is fitted, the plunger filter being suitable to permit the passage of liquid and at the same time to retain solids. The plunger rod passes through the insert, for example a lid, such that the filter plunger can be operated from the outside via the gripping element. If the insert is a lid, it can serve to guide the filter plunger and to restrict the movement clearance thereof in order to only permit a vertical movement.

Whereas, in conventional “French-Press” beverage makers, the spout is formed on the receptacle, the present invention makes it possible in particular to configure the spout directly on the insert without there being the risk of the insert dropping together with the spout out of the receptacle during pouring.

If the insert is designed as a lid with a covering wall which partially covers the receptacle upward and, together with the receptacle, bounds a receptacle interior, the lid, preferably with a skirt extending vertically downward, projects into the receptacle from above and has, preferably on the radial exterior thereof, a circumferential seal which is suitable for producing a seal between the lid and the receptacle in the region of the inner circumferential surface area of the side wall thereof. It is ensured by a seal of this type that, during pouring, liquid cannot escape in an uncontrolled manner between the receptacle and the lid. In this case, the lid skirt which projects into the receptacle can comprise, for example, slot-shaped apertures in order to permit the beverage to be poured out through the apertures via a spout formed on the receptacle. However, the spout may also be formed on the lid itself, as has already been stated above. In this case, the lid preferably has a pouring opening which is arranged between the plunger rod and the spout, perforates the covering wall and forms a connection between the receptacle interior and the spout in order to pour liquid out of the receptacle through the pouring opening via the spout. In this case, it is possible to configure the pouring opening such that it can easily be closed to the outside, for example by an externally accessible lever, in order to minimize heat losses through the lid.

The insert may be configured as an annular retaining element instead of as a lid, the retaining element being designed to rest, for example by means of a circumferential annular flange, on the upper edge of the receptacle and, thereby, to retain a filter insert. The filter insert then rests, for example by means of a supporting flange, on the retaining element and serves to separate solid parts in the beverage from liquid parts. The filter insert then preferably has a preferably cylindrical side wall extending in a vertical direction from an upper end region to a lower end region of the filter insert, and a bottom part which is connected to the side wall and downwardly bounds the filter insert. The retaining element projects at least partially from above into the receptacle. The spout may be formed either on the receptacle or on the retaining element. In a preferred embodiment, the spout is formed on the receptacle and the retaining element has a skirt which extends into the receptacle and on the outer circumferential surface area of which a circumferential seal is formed. Said retaining element then has at least one aperture, through which liquid can be poured, above the circumferential seal in the skirt.

In one possible embodiment, the receptacle holder comprises an upper ring which embraces the side wall of the receptacle, and a plurality of struts which extend in the longitudinal direction of the receptacle and are connected indirectly to one another in the lower region of the receptacle, for example via a lower embracing ring, or are connected directly to one another below the bottom surface of the receptacle.

For easy grasping of the beverage maker, the receptacle holder may have a handle. However, the receptacle may, for example, also have an integrated handle itself, which handle can be manufactured, for example, integrally with the receptacle.

The protruding element may be arranged adjacent to the upper end of the handle belonging to the receptacle holder, i.e. therefore diametrically opposite the spout, and may be connected to said end, for example via a fixing screw. In particular, said element may be in the form of a bow which, in the region of one of the two limbs thereof, has a recess for receiving a lug or a stud on the insert.

However, the receptacle holder may also itself protrude with a side wall region over the upper edge of the receptacle, for example with an annular region embracing the receptacle in the region of its upper end. Said region preferably extends over a considerable angular range, for example over at least 30°. Said protruding region of the receptacle holder may comprise as the first engagement structure at least one groove, preferably two diametrically opposite grooves, on its inner circumferential surface area, said groove or grooves acting as a bayonet joint, for example together with one or two lugs fitted on an outer circumferential surface area of the insert. The groove may consist, for example, of a vertical, upwardly open inlet groove and of a horizontal radial groove which extends from the latter in the circumferential direction, in order to permit simple and rapid locking of the receptacle to the insert.

### BRIEF DESCRIPTION OF THE DRAWINGS

Preferred embodiments of the invention are described below with reference to the drawings, in which:

FIG. 1 shows a perspective view of a beverage maker according to a first embodiment in the unlocked state;

FIG. 2 shows a perspective view of the beverage maker from FIG. 1 in the locked state;

FIG. 3 shows a central longitudinal section in the plane A-A through the beverage maker from FIG. 1;

FIG. 4 shows a perspective view of a beverage maker according to a second embodiment;

FIG. 5 shows a perspective view of the beverage maker from FIG. 4 in the unlocked state;

FIG. 6 shows a perspective view of the beverage maker from FIG. 4 in the locked state;

FIG. 7 shows a partial view of a central longitudinal section in the plane B-B through the beverage maker from FIG. 4; and

FIG. 8 shows a perspective partial view of a partially dismantled beverage maker according to a third embodiment.

### DESCRIPTION OF PREFERRED EMBODIMENTS

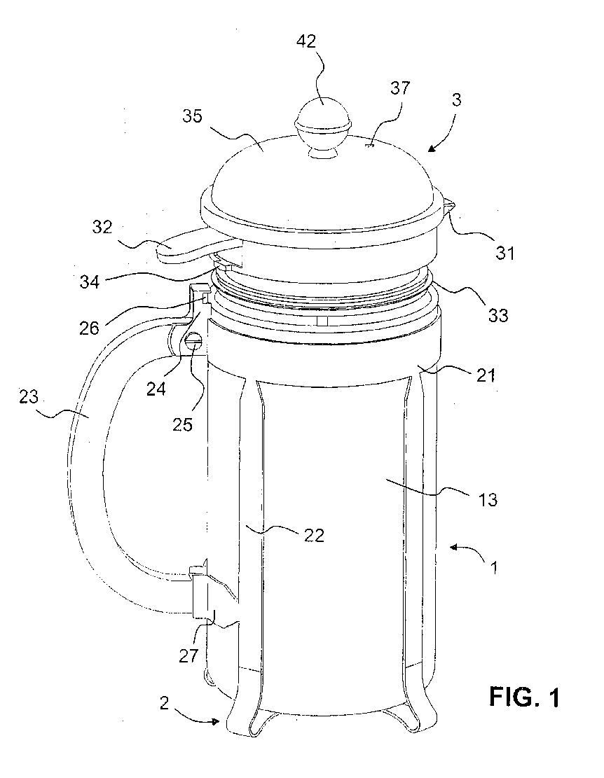

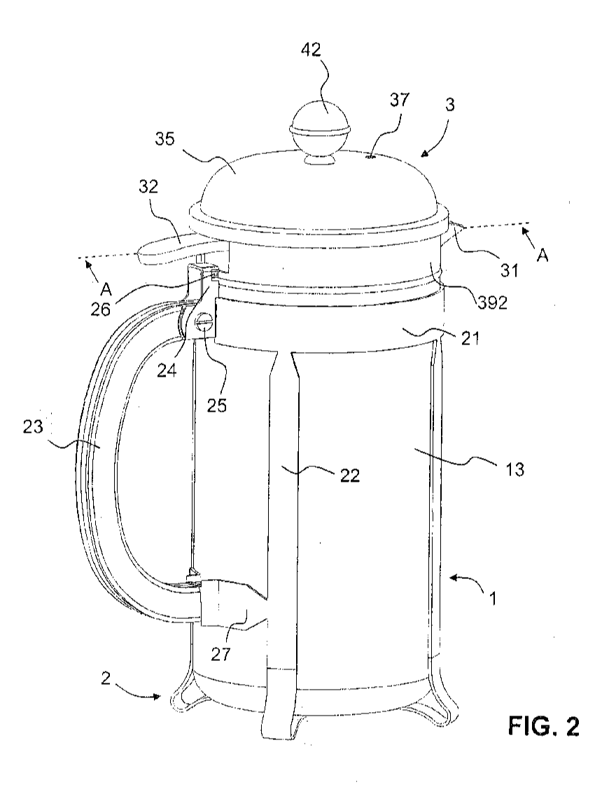

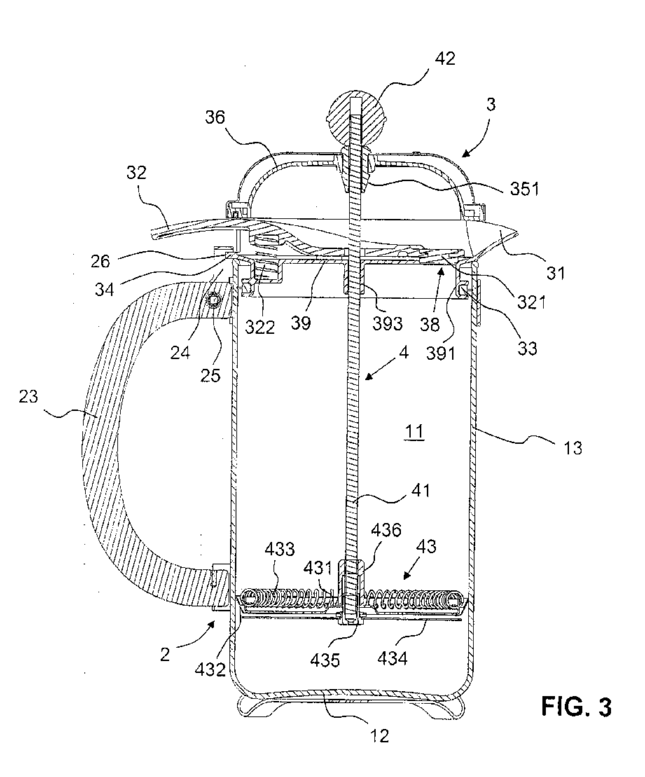

FIGS. 1 to 3 show different illustrations of a first exemplary embodiment of a beverage maker according to the invention.

The beverage maker has a cylindrical, upwardly open glass receptacle 1 with a circumferential side wall 13 and a substantially flat, but slightly upwardly curved bottom 12, a receptacle holder 2 and a lid 3. In the present illustrations, the glass receptacle is shown in non-transparent (opaque) form but it may also be transparent or translucent.

A filter plunger 4 is arranged in the glass receptacle, the filter plunger comprising a plunger rod 41, a knob-shaped actuating element 42 fitted to the upper end of said plunger rod, and a plunger filter 43 of a type known per se which is fitted to the lower end of the plunger rod. The plunger rod is arranged vertically and passes through the lid 3. The plunger filter 43 comprises an upper perforated plate 431 which is raised at its outer border and is provided with a multiplicity of small openings. A toroidal wire coil 433 is threaded through said openings. A fine wire mesh 432 rests on the lower side of the perforated plate 431 and is drawn upward beyond the wire coil 433. The wire mesh 432 is downwardly fixed by a star-like or perforated-plate-like fixing plate 434 mounted parallel to the perforated plate below the wire mesh. The perforated plate 431, the wire mesh 432 and the fixing plate 434 are secured on the plunger rod by a common fixing screw 435 which engages in a counternut 436.

The lid 3 projects partially by a skirt-like section 391 into the glass receptacle 1. A lower covering wall substantially covers the opening in the glass receptacle 1 and, together with the glass receptacle, bounds the receptacle interior 11. A pouring opening 38 is formed in the lower covering wall 39. Starting from the lower covering wall 39, a cylindrical side wall 392 extends upward at the outer border of said covering wall, said side wall being interrupted by a spout 31 and by a recess for a lever 32. Also starting from the lower covering wall 39, a circumferential, cylindrical skirt 391 of somewhat smaller diameter extends downward into the receptacle. A pair of annular, spaced-apart webs extends outward from the skirt, forming a receptacle for a circumferential, annular seal 33 having a radially outwardly protruding sealing lip. By this means, after the lid 3 has been inserted, a seal is formed between the receptacle 1 and the lid, the seal preventing liquid from being able to escape between the receptacle and lid.

An elongate lever 32 which extends above the lower covering wall 39 transversely with respect to the plunger rod 41 is fitted to the lid 3 in a manner such that it can pivot about a horizontal axis. In the region of its front end, the lever comprises a closure body 321 in order to close the pouring opening 38. At its rear end facing away from the spout 31, the lever 32 protrudes radially with an actuating region out of the lid 3 and, by pressure being applied by the user's thumb, can pivot downwards slightly about its horizontal pivot axis such that the closure body 321 is raised from the pouring opening 38 and opens up the pouring opening. In the direction of its first position, the lever is spring-loaded by a helical spring 322 in order to ensure that the pouring opening is closed if the lever is not being consciously actuated. The helical spring 322, which is preloaded into the closing position, is formed in the rear lever region facing away from the spout 31, still within the lid 3. In order to guide the plunger rod 41 through the lid 3, the lever has a passage opening, but may also be guided laterally around the plunger rod.

An upwardly curved, double-walled upper dome, consisting of an inner covering wall 36 and an outer covering wall 35, extends from the upper edge of the cylindrical side wall of the lid 3. The double-walled configuration of the upper dome minimizes the heat loss through the lid. In addition, this design makes it possible to form the outer covering wall in an aesthetically attractive manner, for example from thin sheet metal, irrespective of any stability requirements. A vertical guide sleeve 351 in which the plunger rod 41 of the filter plunger 4 is guided is inserted into a central opening in the inner covering wall 35. The lever 32 and the lower covering wall 39 each have a passage opening through which the plunger rod is likewise guided. A further guide sleeve 393 is formed as a single piece with the lower covering wall 39 and extends downward from the latter.

The receptacle holder 2 comprises a retaining ring 21 which embraces the side wall 13 of the glass receptacle 1 in the upper region of the receptacle, and struts 22 extending in the longitudinal direction of the vessel. In the region where the side wall 13 of the glass receptacle 1 meets the bottom 12, said longitudinal struts form feet which project outward and downward and permit the beverage maker to be placed onto a flat underlying surface without the glass receptacle 1 which is heated by the beverage coming into contact with the underlying surface. The longitudinal struts 22 are connected to one another below the bottom 12 of the glass receptacle. The upper end of a handle 23 is connected to the retaining ring 21 and the lower end of said handle is connected to the receptacle holder 2 via a transverse strut 27 connecting two longitudinal struts 22.

A bow-like element 24 which protrudes over the glass receptacle 1 and has two limbs and a connecting region connecting the latter is fastened to the handle 23 by means of a fixing screw 25. The element projects beyond the retaining ring 21 and the upper edge of the glass receptacle 1. A recess which forms a radial groove 26 is formed in the region of one of the limbs of the bow on the part projecting over the glass receptacle. Said radial groove is designed to receive a lug 34 which is fitted to the exterior of the side wall 392 of the lid 3 below the closure lever 32. By means of a rotational movement over a small angular range and the latching of the lug 34 into the radial groove 26, a bayonet joint is formed, by means of which the lid 3 can be locked releasably to the glass receptacle 1. A marking 37 on the exterior of the upper, outer covering wall 35 of the lid 3 indicates the correct positioning for latching and locking the lid 3 to the glass receptacle 1.

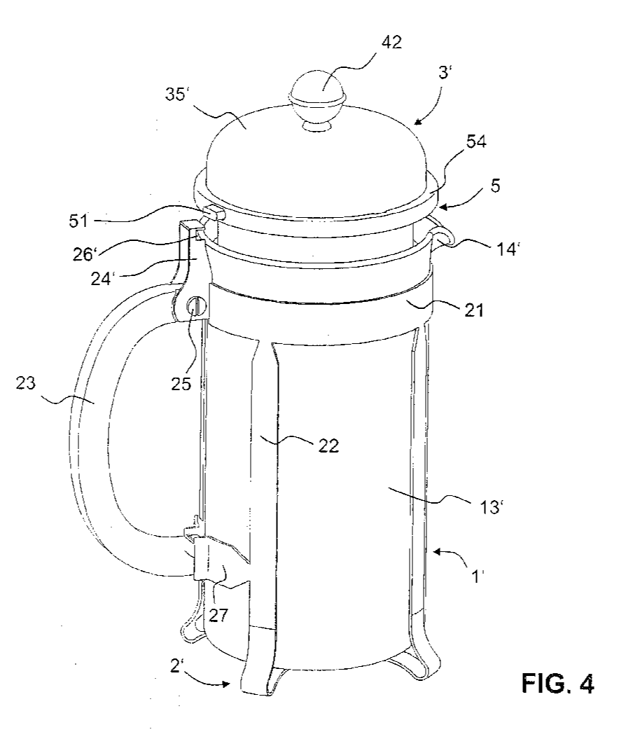

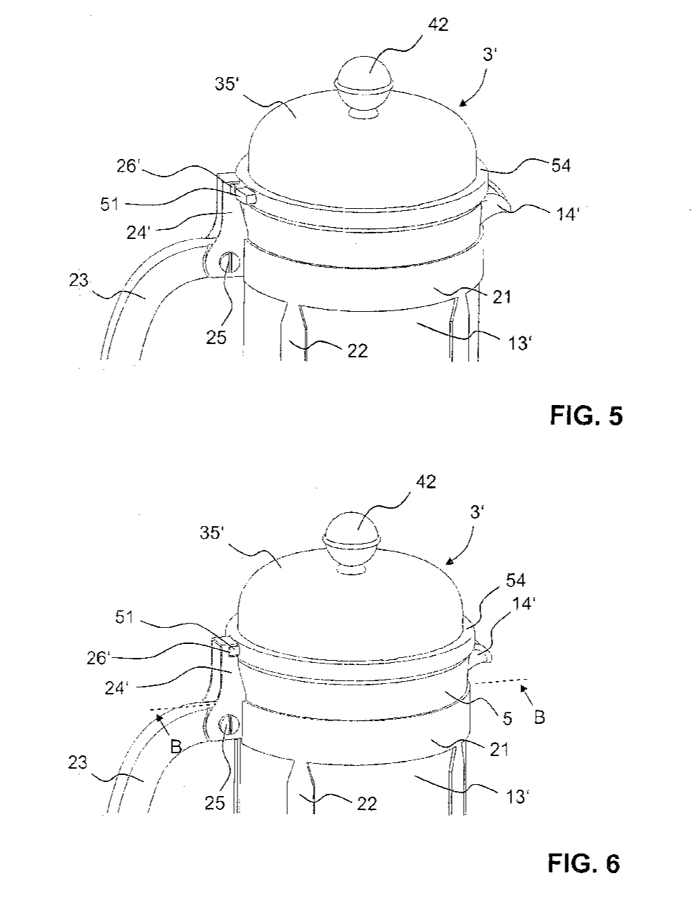

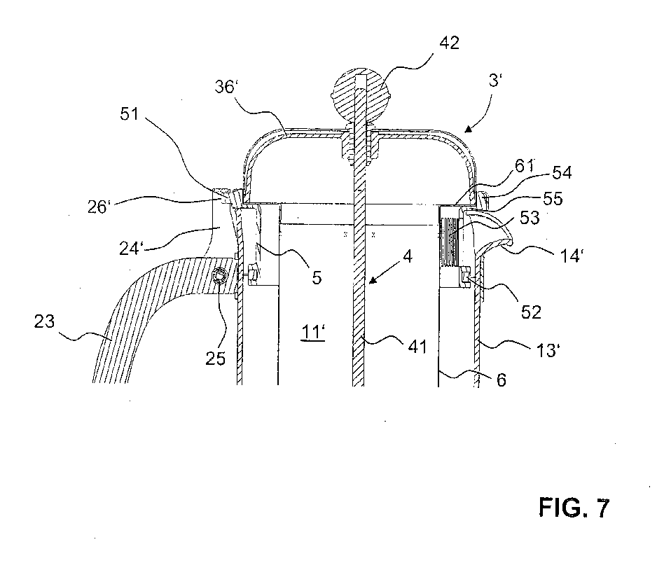

A further exemplary embodiment is illustrated in FIGS. 4 to 7 in which identical parts are provided with the same reference numbers as in FIGS. 1 to 3. In contrast to the first embodiment, in this embodiment, the beverage maker additionally has a filter insert 6 and an annular retaining element 5 therefor.

The filter insert 6 has a circumferential side wall and a bottom (not illustrated) which is adjacent to the side wall at the bottom. The cylindrical side wall has a multiplicity of small openings or holes through which liquid can pass but which are smaller than the solid beverage constituents which are intended to be filtered out when preparing the beverage. A circumferential, radially outwardly protruding flange 61 is provided on the upper edge of the filter insert 6. The flange is used to enable the filter insert to rest on the retaining element 5 into which the filter insert is pushed.

The filter insert 6 serves to separate solid constituents of the beverage from liquid constituents while the filter plunger 4 is being pressed down. The use of the filter insert enables the plunger filter 43 to be pressed downwards more rapidly and with less application of force because liquid beverage constituents can be displaced not only through the plunger filter itself but also through the side wall of the filter insert 6. Furthermore, because of the filter insert, the glass receptacle is subjected to a less severe loading when the filter plunger is pressed down, thus reducing the risk of the glass breaking. Finally, the filter insert permits greater design freedom with respect to the shape of the glass receptacle 1′.

The retaining element 5 rests on the upper rim of the glass receptacle 1′, the retaining element having for this purpose a radially protruding supporting structure in the form of a circumferential, radial supporting flange 55. The retaining element extends with an annular, circular-cylindrical side wall (skirt) from above into the glass receptacle 1′ to an extent such that said retaining element protrudes downward over the spout 14′ which, in this exemplary embodiment, is formed on the glass receptacle 1′. A radially outwardly pointing, circumferential sealing lip 52 is formed in the region of the lower end of the retaining element 5, said sealing lip bearing against the interior of the side wall 13′ of the glass receptacle below the spout 14′ and thereby producing a seal between the retaining element 5 and the glass receptacle 1′. A multiplicity of slot-shaped apertures 53 serving as pouring openings are provided over a small angular range in the side wall of the retaining element. The presence of the sealing lip 52 means that liquid can only pass through said apertures 53 to the spout 14′ when the liquid is intended to be poured out of the receptacle.

The plunger rod 41 is guided through a central opening in a lid 3′. The open, lower end of the lid 3′ can be pushed into the retaining element 5 and fixed releasably thereto. For this purpose, the retaining element 5 has an upwardly extending annular flange 54 which serves as a receiving ring and extends upward from the radially outer border of the supporting flange 55. The lid 3′ is locked releasably to the retaining element 5 by means of a bayonet joint which is not visible in the drawings. For this purpose, a lug fitted to the radial exterior on the lower border of the lid 3′ can be inserted from above into a vertical inlet groove which is formed on the radial interior of the annular flange 54 and which is adjoined by a horizontal radial groove extending over a small angular range of, for example 5°-15° of the flange circumference. By means of a rotational movement of the lid 3′, the lug engages in the radial groove, as a result of which the lid 3′ is locked releasably to the retaining element 5. The lid 3′ can thereby be fixed releasably in the retaining element 5. Instead, however, there may also be a simple latching connection. The lid 3′ is of double-walled design with an outer covering wall 35′ and an inner covering wall 36′ which upwardly bounds the receptacle interior 11′.

In order to lock the retaining element 5 releasably to the glass receptacle 1′, the retaining element 5 on the radial exterior of the annular flange 54 has a bayonet lug 51 which is fitted to the diametrically opposite side with respect to the apertures 53. As in the first exemplary embodiment, a bow-like, protruding element 24′ is fitted to the receptacle holder and, in this embodiment, is designed to be somewhat longer than in the first exemplary embodiment. The protruding element 24′ is fitted to the handle 23 of the receptacle holder 2′ by means of the fixing screw 25 and extends upward along the side wall 13′ beyond the upper rim of the glass receptacle 1′. Said bow-shaped, protruding element 24′ also has in the region of one of the limbs thereof a recess which forms a radial groove 26′. By means of a rotational movement, the lug 51 of the retaining element 5 can be introduced into the radial groove 26′ and can be locked to the latter in the manner of a bayonet joint. By means of the releasably locked connection between the retaining element 5 and the glass receptacle 1′, the apertures 53 are directed toward the spout 14′ in a well defined position in the locked state, as a result of which the beverage can be poured out through the apertures 53 and via the spout 14′. The retaining element 5 or the lid 3′ is prevented from slipping by the locking of the two engagement structures 51 and 26.

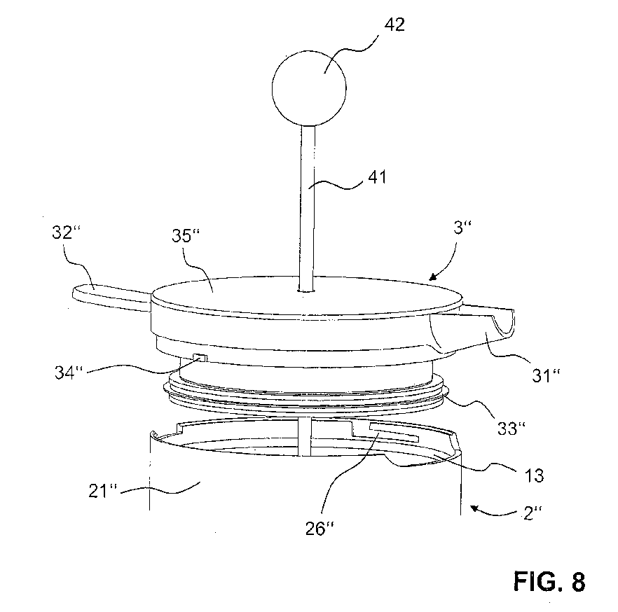

A further exemplary embodiment is depicted in FIG. 8. The functional features of this embodiment, with the exception of the latching connection between the lid 3″ and the receptacle holder 2″, are analogous to the features described in the first exemplary embodiment (FIGS. 1 to 3).

The receptacle holder 2″ protrudes upward with a ring 21″, which embraces the glass receptacle, over the side wall 13 of the glass receptacle and along the entire circumference of the side wall 13. In the protruding part of the ring 21″, a first cutout is formed at the upper edge, the cutout leaving space for the spout 31″ of the lid 3″ and leaving additional space in order to allow a rotational movement of the lid 3″ in the ring 21″ over a small angular range. On the diametrically opposite side of the first cutout, a second cutout is formed on the upper edge of the ring 21″ in order to enable the closure lever 32″ to be pressed downward in the locked state.

In the interior of its circumferential surface area, the ring 21″ of the receptacle holder 2″ has two identical engagement structures 26″ which lie diametrically opposite each other. The engagement structures 26″ each consist of a vertically formed, upwardly open inlet groove and a horizontally extending radial groove which is adjacent to the inlet groove in the lower region. The two lugs 34″ which are formed on the exterior of the lid 3″ and are each arranged at half the angle between the spout 31″ and closure lever 32″ are configured in such a manner that they can be introduced into the vertical inlet grooves of the engagement structures 26″ upon correct insertion of the lid 3″. By means of a rotational movement over a small angular range, the lugs 34″ are introduced into the radial grooves of the engagement structures 26″ and latch therein when the rotational movement is fully executed. As a result, the lid 3″ is locked releasably to the receptacle holder 2″.

Of course, the invention is not restricted to the above examples, and a multiplicity of modifications is possible. In particular the two engagement structures 26, 26′, 26″ and 34, 34″ may also be formed differently, in each case matching each other. Instead of rectangular lugs, for example cylindrical bayonet studs may be present. Instead of the receptacle holder illustrated in the drawings, any other holder may also be used if said holder has an element protruding over the glass receptacle. A differently designed lid with or without a spout and with or without a closure mechanism may also be used. A multiplicity of further applications is possible.

### LIST OF REFERENCE NUMBERS

1,1′ Glass receptacle
11,11′ Receptacle interior
12 Bottom
13,13′ Side wall
14′ Spout
2,2′,2″ Receptacle holder
21,21″ Ring
22 Longitudinal struts
23 Handle
24,24′ Protruding element
25 Fixing screw
26,26′,26″ Bayonet radial groove
27 Transverse strut
3,3′,3″ Lid
31,31″ Spout
32,32″ Closure lever
321 Closure body
322 Compression spring
33,33″ Sealing ring
34,34″ Bayonet lug
35,35′,35″ Outer covering wall
351 Guide sleeve
36,36′ Inner covering wall
37 Marking
38 Pouring opening
39 Lower covering wall
391 Skirt
392 Side wall
393 Guide sleeve
4 Filter plunger
41 Plunger rod
42 Actuating element
43 Plunger filter
431 Base plate
432 Wire mesh
433 Wire coil
434 Fixing plate
435 Fixing screw
436 Counternut
5 Retaining element
51 Bayonet lug
52 Sealing ring
53 Aperture
54 Annular flange
55 Supporting flange
6 Filter insert
61 Supporting flange

1. A beverage maker, comprising
an upwardly open receptacle with a receptacle bottom, a circumferential side wall and an upper opening;
a receptacle holder at least partially embracing the side wall of the receptacle;
an insert which is inserted into the upper opening in the receptacle and projects into said receptacle;
the receptacle holder comprising a side wall with a region forming at least one element which protrudes upward over the upper edge of the receptacle and the receptacle holder further comprising a first engagement structure, and
the insert comprising at least one second engagement structure which interacts with the first engagement structure in such a manner that the insert is releasably lockable in relation to the receptacle holder by means of a rotational movement,
wherein said protruding region of the receptacle holder as the first engagement structure comprises at least one groove on its inner surface area.

2. The beverage maker as claimed in claim 1, wherein the engagement structures form a bayonet joint.

3. The beverage maker as claimed in claim 1, wherein the receptacle comprises a cylindrical basic shape, wherein the beverage maker comprises a filter plunger which is displaceable vertically in the receptacle and encompasses a plunger rod, to the upper end of which an actuating element is fitted, and to the lower end of which a plunger filter is fitted, said plunger filter being suitable to permit the passage of liquid and at the same time to retain solids, and wherein the plunger rod passes through the insert.

4. The beverage maker as claimed in claim 1, wherein a spout is formed on the insert.

5. The beverage maker as claimed in claim 1, wherein the insert is configured as a lid which comprises a covering wall which at least partially covers the receptacle upward and, together with the receptacle, bounds a receptacle interior.

6. The beverage maker as claimed in claim 1, wherein the insert is configured as an annular retaining element which is designed to rest on the upper edge of the receptacle and, as it does so, to retain a filter insert.

7. The beverage maker as claimed in claim 1, wherein the insert comprises, on the radial exterior thereof, a circumferential seal which is suitable for producing a seal between the insert and the receptacle in the region of the inner surface area of the side wall thereof.

8. The beverage maker as claimed in claim 7, wherein the side wall of the insert above the circumferential seal comprises at least one aperture through which liquid can be poured.

9. The beverage maker as claimed in claim 1, wherein the receptacle holder comprises an upper ring which embraces the side wall of the receptacle, and struts which extend in the longitudinal direction of the receptacle and are connected to one another in the lower region of the receptacle, and wherein the protruding element extends upward from the ring.

10. The beverage maker as claimed in claim 1, wherein the receptacle holder comprises a handle for grasping the beverage maker.

11-13. (canceled)

14. The beverage maker as claimed in claim 1, wherein said protruding region of the receptacle holder as the first engagement structure comprises two diametrically opposite grooves.

15. The beverage maker as claimed in claim 1, wherein on the exterior of the insert at least one lug is formed as the second engagement structure, which lug can be introduced into the groove of the first engagement structure.

16. The beverage maker as claimed in claim 1, wherein the first engagement structure comprises a vertical inlet groove which is upwardly open and a horizontally extending radial groove adjacent to the inlet groove and arranged in the lower region of the inlet groove.

17. The beverage maker as claimed in claim 4, wherein the protruding region of the receptacle holder comprises a cutout at the upper edge, the cutout leaving space for the spout.

18. The beverage maker as claimed in claim 17, wherein the cutout is dimensioned such, that a rotational movement of the insert relative to the receptacle holder is allowed.
